(19) United States
(12) Patent Application Publication
(10) Pub. No.: US 2022/0332661 A1
(43) Pub. Date: Oct. 20, 2022

(54) MOISTURE TOLERANT FERTILIZER GRANULES, COMPOSITIONS AND METHODS OF MAKING

(71) Applicant: Agrium Inc., Calgary (CA)

(72) Inventors: Baozhong Xing, Loveland, CO (US); John Harrison, Loveland, CO (US)

(21) Appl. No.: 17/762,645

(22) PCT Filed: Sep. 25, 2020
(86) PCT No.: PCT/US2020/052689

§ 371 Date: Mar. 22, 2022

Related U.S. Application Data
(60) Provisional application No. 62/905,805, filed on Sep. 25, 2019.

(51) Int. Cl. C05G 5/30; C05C 3/00; C05G 5/12

(52) U.S. Cl. CPC C05G 5/37; C05C 3/00; C05G 5/12

(57) ABSTRACT

A moisture tolerant fertilizer granule includes a core and a polyurethane polymer coating disposed on the core. The core includes a hygroscopic plant nutrient. The polyurethane polymer coating is from 0.5 wt.% to 1.9 wt.% of hygroscopic plant nutrient.

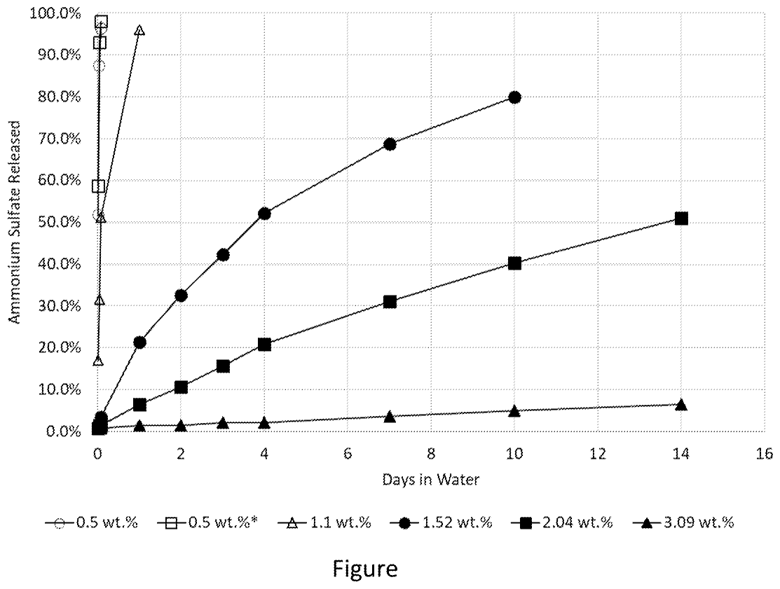

### CROSS REFERENCE TO RELATED APPLICATION

This application is a U.S. 371 National Stage application of the International Patent Application No. PCT/US2020/052689, filed Sep. 25, 2020, which claims priority to Provisional Application No. 62/905,805, filed Sep. 25, 2019, which are both herein incorporated by reference in its entirety.

### TECHNICAL FIELD

The present disclosure relates generally to fertilizer compositions. Specifically, the disclosure relates to coated fertilizer granules and compositions including coated fertilizer granules with improved moisture tolerance.

### BACKGROUND

Fertilizers including plant nutrients in granular form are well known in the art for enhancing the productivity of soil. The granular nature of such fertilizers permits the fertilizer to be handled efficiently in transportation and to be evenly applied to the soil. Some plant nutrients are hygroscopic, that is, they tend to adsorb or absorb water from the air. Under conditions of high relative humidity followed by lower relative humidity, granular hygroscopic plant nutrients can take up water and then recrystallize as the water evaporates. The recrystallization can cause the plant nutrient granules to clump together, or cake, forming lumps of fertilizer that may be difficult to handle and may require significant force to break up and return to granular form.

Some granulated fertilizers are provided with a coating in an attempt to block the absorption of water by the hygroscopic plant nutrient. Such coatings may include organic solutions, such as petroleum-based hydrocarbons, waxes, and thermoplastics that do not provide a significant improvement in the clumping of the granulated fertilizer.

### SUMMARY

Example 1 is a moisture tolerant fertilizer granule including a core and a polyurethane polymer coating disposed on the core. The core includes a hygroscopic plant nutrient. The polyurethane polymer coating is from 0.5 wt. % to 1.9 wt. % of the hygroscopic plant nutrient.

Example 2 is the moisture tolerant fertilizer granule of Example 1, wherein the polyurethane polymer coating is from 0.6 wt. % to 1.5 wt. % of the hygroscopic plant nutrient.

Example 3 is the moisture tolerant fertilizer granule of Example 1, wherein the polyurethane polymer coating is from 0.7 wt. % to 1.4 wt. % of the hygroscopic plant nutrient.

Example 4 is the moisture tolerant fertilizer granule of Example 1, wherein the polyurethane polymer coating is from 0.9 wt. % to 1.3 wt. % of the hygroscopic plant nutrient.

Example 5 is the moisture tolerant fertilizer granule of any of Examples 1-4, wherein the hygroscopic plant nutrient includes an ammonium salt.

Example 6 is the moisture tolerant fertilizer granule of any of Examples 1-5, wherein the hygroscopic plant nutrient includes ammonium sulfate.

Example 7 is the moisture tolerant fertilizer granule of Example 6, wherein the hygroscopic plant nutrient consists essentially of ammonium sulfate.

Example 8 is a fertilizer composition including a moisture tolerant fertilizer composition. The moisture tolerant fertilizer composition includes moisture tolerant fertilizer granules. Each of the moisture tolerant fertilizer granules includes a core and a polyurethane polymer coating disposed on the core. The core includes a hygroscopic plant nutrient. The polyurethane polymer coating is from 0.5 wt. % to 1.9 wt. % of the hygroscopic plant nutrient.

Example 9 is the fertilizer composition of Example 8, wherein the polyurethane polymer coating is from 0.7 wt. % to 1.4 wt. % of the hygroscopic plant nutrient.

Example 10 is the fertilizer composition of Example 8, wherein the polyurethane polymer coating is from 0.9 wt. % to 1.3 wt. % of the hygroscopic plant nutrient.

Example 11 is the fertilizer composition of any of Examples 8-10, wherein the hygroscopic plant nutrient includes an ammonium salt.

Example 12 is the fertilizer composition of any of Examples 8-11, wherein the hygroscopic plant nutrient includes ammonium sulfate.

Example 13 is the fertilizer composition of any of Examples 8-12, further comprising a controlled release fertilizer composition.

Example 14 is the fertilizer composition of Example 13, wherein the controlled release fertilizer composition includes at least one compound selected from the group of urea, phosphorous pentoxide and potassium oxide.

Example 15 is a process for producing a moisture tolerant fertilizer composition. The process includes contacting granules including a hygroscopic plant nutrient with a mixture comprising a polyol and an isocyanate, and curing the mixture to form a polyurethane polymer coating on granules including the hygroscopic plant nutrient, wherein the polyurethane polymer coating is from 0.5 wt. % to 1.9 wt. % of the hygroscopic plant nutrient.

Example 16 is the process of Example 15, wherein the polyurethane polymer coating is from 0.6 wt. % to 1.5 wt. % of the hygroscopic plant nutrient.

Example 17 is the process of Example 15, wherein the polyurethane polymer coating is from 0.7 wt. % to 1.4 wt. % of the hygroscopic plant nutrient.

Example 18 is the process of Example 15, wherein the polyurethane polymer coating is from 0.9 wt. % to 1.3 wt. % of the hygroscopic plant nutrient.

Example 19 is the process of Example 15, wherein the hygroscopic plant nutrient includes an ammonium salt.

Example 20 is the process of Example 15, wherein the hygroscopic plant nutrient includes ammonium sulfate.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The FIGURE is a graph of the percentage of ammonium sulfate released as a function of time for various coating weight percentages.

### DETAILED DESCRIPTION

Embodiments of the present disclosure employ thermoset polyurethane coatings on granular hygroscopic plant nutrients to improve their moisture tolerance. It has been found that granular hygroscopic plant nutrients can suffer from two different moisture-related effects that together reduce the moisture tolerance of the granular hygroscopic plant nutrients, particularly in high humidity conditions. The first moisture-related effect is the caking effect described above. This effect can be somewhat successfully dealt with by the polyurethane coatings disclosed in, for example, U.S. Pat. No. 6,663,686, CONTROLLED RELEASE FERTILIZER AND METHOD FOR PRODUCTION THEREOF. The polyurethane coatings disclosed on the controlled release fertilizers are sufficient to form a complete coating, most preferably from about 2 weight percent (wt. %) to about 4 wt. %, based on the weight of the plant nutrient. However, even with such coatings, the granular hygroscopic plant nutrients experience a second moisture-related effect in high humidity conditions under certain storage conditions. Under conditions of high humidity, which can occur at night, for example, moisture condenses on the surface of the granules and flows into the spaces between the fertilizer granules. During conditions of lower humidity, such as during the day, the condensed water may evaporate. However, when the granular fertilizer is in a large pile, such as when the fertilizer is stored in a warehouse, for example, not all of the water may evaporate. Thus, over repeated cycles, water can accumulate within the depths of the pile, flooding the pile of granular fertilizer. Over time, the water can eventually penetrate the coating, dissolve the hygroscopic plant nutrient within, and flow out of the pile, rendering much of the granular fertilizer useless.

It has been found that a polyurethane polymer coating that is a relatively low weight percentage of the combined weight of the hygroscopic plant nutrient core and the coating can balance these two moisture-related effects, increasing the overall moisture tolerance of the fertilizer granules. Without wishing to be bound by any theories, it is believed that a higher weight percentage polyurethane coating which covers the surface of the hygroscopic plant nutrient core more completely, provides a surface for the efficient condensation and accumulation of water, which may flow into the pile and flood the pile. A lower weight percentage polyurethane coating covers the surface of the hygroscopic plant nutrient core less completely, permitting some of the condensed moisture to be absorbed by the hygroscopic plant nutrient core itself, thus reducing the amount of water flowing into the depths of the pile and reducing the flooding effect. During subsequent periods of low humidity, the absorbed moisture, which will generally be near the exterior of the pile, may evaporate more easily from the pile. While the caking effect may be more pronounced with the less complete polyurethane coating, the presence of a significant amount of the polyurethane coating reduces the caking and reduces the effort required to break up any lumps into granules. Thus, the lower weight percentage polyurethane coating provides for reduced flooding effects compared to a higher weight percentage polyurethane coating and also provides for reduced caking effects compared to uncoated fertilizer granules.

According to embodiments of this disclosure, a moisture tolerant fertilizer granule includes a core including a hygroscopic plant nutrient and a polyurethane polymer coating disposed on the core. In some embodiments, the core including the hygroscopic plant nutrient consists essentially of the hygroscopic plant nutrient. As used herein, “consists essentially of the hygroscopic plant nutrient” means the hygroscopic plant nutrient and impurities. In some embodiments, the core including the hygroscopic plant nutrient consists of the hygroscopic plant nutrient.

The polyurethane coating disposed on the core may be as little as 0.5 wt. %, 0.6 wt. %, 0.7 wt. %, 0.8 wt. %, or 0.9 wt. %, or as much as 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, or 1.9 wt. %, or be within any range defined between any two of the foregoing values, such as 0.5 wt. % to 1.9 wt. %, 0.6 wt. % to 1.8 wt. %, 0.7 wt. % to 1.7 wt. %, 0.8 wt. % to 1.6 wt. %. 0.9 wt. % to 1.5 wt. %, 0.5 wt. % to 1.8 wt. %, 0.6 wt. % to 1.5 wt. %, 0.7 wt. % to 1.4 wt. %, 0.9 wt. % to 1.3 wt. %, 0.8 wt. % to 1.2 wt. %, 0.9 wt. % to 1.1 wt. %, 1.0 wt. % to 1.3 wt. %, or 0.7 wt. % to 1.3 wt. %, for example. All weight percentages as a percentage of the plant nutrient material.

In some embodiments, the hygroscopic plant nutrient may include calcium nitrate, an ammonium salt, such as ammonium sulfate or ammonium nitrate, or combinations thereof. In some embodiments, the hygroscopic plant nutrient may further include urea.

Ammonium sulfate is a particularly important plant nutrient for some crops, such as canola and soybean, as it provides both nitrogen and sulfur at the same time. In some embodiments, the hygroscopic plant nutrient may include ammonium sulfate. In some embodiments, the hygroscopic plant nutrient may consist essentially of ammonium sulfate. As used herein, “consist essentially of ammonium sulfate” means ammonium sulfate and impurities. In some embodiments, the hygroscopic plant nutrient may consist of ammonium sulfate.

A moisture tolerant fertilizer composition according to embodiments of this disclosure, includes the moisture tolerant fertilizer granules as described above. A fertilizer composition according to embodiments of this disclosure includes the moisture tolerant fertilizer composition.

In some embodiments, the fertilizer composition may further include a controlled release fertilizer composition including controlled release fertilizer granules, such as those described in U.S. Pat. No. 6,663,686, CONTROLLED RELEASE FERTILIZER AND METHOD FOR PRODUCTION THEREOF, which is incorporated herein by reference in its entirety. The controlled release fertilizer granules include a plant nutrient surrounded by a polyurethane coating. The polyurethane coating is most preferably from about 2.0 wt. % to about 4.0 wt. % of the weight of the plant nutrient so that the coating surrounds the plant nutrient. In some embodiments, the controlled release fertilizer granules may include at least one plant nutrient selected from the group of urea, phosphorous pentoxide and potassium oxide.

A process for producing a fertilizer composition can include mixing a moisture tolerant fertilizer composition, according to embodiments described above, with a controlled release fertilizer composition, as described above.

A process for producing the moisture tolerant fertilizer composition can include contacting granules including the hygroscopic plant nutrient with a mixture including an isocyanate and a polyol, and then curing the mixture to form a polyurethane polymer coating on the granules. The coating may be applied as a single-layer coating, or may be applied as two or more coating layers.

The granules including the hygroscopic plant nutrient can have a diameter as small as about 1 mm, 1.1 mm, 1.2 mm, 1.3 mm, 1.4 mm, 1.5 mm, 1.6 mm, 1.7 mm, 1.8 mm or 1.9 mm, or as large as about 2 mm, 2.1 mm, 2.2 mm, 2.3 mm, 2.4 mm, 2.5 mm, 2.6 mm, 2.7 mm, 2.8 mm, 2.9 mm or 3 mm, or be within any range defined between any two of the foregoing values, such as about 1 mm to 3 mm, 1.1 mm to 2.9 mm, 1.2 mm to 2.8 mm, 1.3 mm to 2.7 mm, 1.4 mm to 2.6 mm, 1.5 mm to 2.5 mm, 1.6 mm to 2.4 mm, 1.7 mm to 2.3 mm, 1.8 mm to 2.2 mm, 1.9 mm to 2.1 mm, 1 mm to 3 mm, 1.5 mm to 2 mm, or 1 mm to 1.8 mm, for example.

The isocyanate may be a diisocyanate or a polyisocyanate. Isocyanates contain two or more —NCO groups available for reaction and, as known to one skilled in the art, are widely used in the production of urethane polymers. Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethanie diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitoluene diisocyanate, 1,4-xylylene diisocyanate, 1,3-xylylene diisocyanate, bis-(4-isocyanatophenemethane, bis-(3-methyl-4-isocyanatophenyl)methane, and mixtures thereof.

Non-limiting examples of polyols include diethylene glycol polyol, ethylene glycol, polypropylene glycol, organic polyols, orthophathalate diethylene glycol based polyester polyols, terephthalate-diethylene glycol based polyester polyols, castor oil and oils modified to contain amine or OH groups, for example modified tung oil, vegetable oils such as soybean oil, canola oil, sunflower oil, linseed oil; oleo-polyols, for example epoxidized castor oil, epoxidized sunflower oil, epoxidized linseed oil; polyether polyols, castor oil derivatives, for example partial hydrolysates of castor oil formed by reacting castor oil with a polyol selected from diols (e.g. ethylene glycol, propylene glycol, 1,4-butanediol, neopentyl glycol, 1,6-hexanediol, diethylene glycol, dipropylene glycol, polyethylene glycol, and polypropylene glycol), glycerol, trimethylolpropane, and polyether polyol, or any combinations thereof.

A ratio of NCO groups from the isocyanate to the hydroxyl groups in the polyol can be as low as about 0.8:1, 0.9:1, 1:1, 1.1:1, or 1.2:1, or as high as 1.3:1, 1.5:1, 2:1, 2.5:1 or 3:1, or be within any range defined between any two of the foregoing values, such as 0.8:1 to 3:1, 0.9:1 to 2.5:1, 1:1 to 2:1, 1.1:1 to 1:5:1, 1.2:1 to 1.3:1, 0.8:1 to 2:1, 0.8:1 to 1.5:1, 0.8:1 to 1.2:1, or 1.3:1 to 2.5:1, for example.

The fertilizer composition according to embodiments of this disclosure may be produced using a rotating drum to produce the polyurethane polymer coating over and around the granules including the hygroscopic plant nutrient. In this process, the granules may be fed from a storage area, onto a conveyor and then fed into a rotating drum. In the rotating drum, the granules may be heated and then the heated granules coated with the isocyanate and the polyol to produce the polymer coating. For example, 4,4′-diphenylmethanie diisocyanate and diethylene glycol, optionally mixed with a catalyst are simultaneously or sequentially applied to the granular hygroscopic plant nutrient, polymerizing on the surface of the granules to form the polymer coating. The catalyst can include metals, such as lead or zinc, or amine compounds, such as triethanolamine, for example.

The granules including the hygroscopic plant nutrient may be heated in the rotating drum to a temperature as low as about 50° C., 52° C., 54° C., 56° C., 58° C., 60° C., 62° C., 64° C., 66° C., 68° C., 70° C., 72° C., 74° C., 76° C., 78° C. or 80° C., or as high as about 82° C., 84° C., 86° C., 88° C., 90° C., 92° C., 94° C., 96° C., 98° C., 100° C., 102° C., 104° C., 110° C., 115° C. or 120° C., or be within any range defined between any two of the foregoing values, such as from about 50° C.-120° C., 60° C.-110° C., 70° C.-100° C., 80° C.-90° C., 60° C.-80° C. or 90° C.-100° C., for example.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

Throughout this disclosure, where a process or method is shown or described, the method may be performed in any order or simultaneously, unless it is clear from the context that the method depends on certain actions being performed first.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Test Group Preparation

Six test groups were prepared by coating ammonium sulfate (AMS) granules with various weight percentages of a polyurethane. For each test group, 1 kg of ammonium sulfate granules was loaded into a 12-inch diameter drum and heated to 70° C. with an electric heat gun while the drum was rotating. A polyol was heated to 115° C. and applied to the granules simultaneously with the isocyanate at a mole ratio of NCO:OH of about 1:1. For test groups coated in two layers, half of the desired coating weight percentage was applied, then the granules rotated and heated for a first layer cure time, then the other half of the desired coating weight percentage was applied, and the granules rotated and heated for a second layer cure time. After the final cure time, the heat was no longer applied and the coated granules were cooled with compressed air with continued rotation. After 10 minutes of cooling, drum rotation was stopped and the test group removed from the drum. The coating weight percentages and curing conditions for each test group are shown in Table 1 below. All curing was at 70° C.

TABLE 1

| Test Group | 1 | 2 | 3 | 4 | 5 | 6 |
|---|---|---|---|---|---|---|
| Total Coating (Wt. %) | 0.5% | 0.5% | 1.1% | 1.52% | 2.04% | 3.09% |
| Number of Layers | 2 | 1 | 2 | 2 | 2 | 2 |
| 1^{st} Layer Cure Time (minutes) | 5 | 15 | 10 | 9 | 9 | 9 |
| 2^{nd} Layer Cure Time (minutes) | 10 | — | 15 | 14 | 14 | 12 |

Samples of each of the test groups were evaluated for AMS release rate in water, flooding resistance and caking resistance, as described below.

### AMS Release Rate

The following example demonstrates the release rate of AMS to determine the relative level of water permeability of the coating for each test group. For each test group, a 10-gram sample was placed into a 125-mL bottle with 90 g of water, and the bottle capped. The refractive index of each test group was measured in situ periodically to determine the percentage of ammonium sulfate released from the coated granules. The results are shown in the FIGURE.

The FIGURE is a graph of the percentage of ammonium sulfate released as a function of time for various coating weight percentages. As shown in the FIGURE, coating amounts above about 2 wt. % show a controlled release profile with half or less of the of the AMS released after two weeks. Coating amounts less than 2 wt. % show double the release rate, with coating amounts around 1 wt. % releasing over 90% of the AMS in a day. Thus, it appears that a coating of less than 2 wt. %, and especially about 1 wt. % or less provides an incomplete coating of the AMS granules and does not provide a controlled release profile, as shown by the high AMS release rate.

### Moisture Tolerance

The following example demonstrates the moisture tolerance for each test group. Moisture tolerance considers both the point at which caking is observed, as indicated by the agglomeration of the granules into big granules, and the point at which flooding is observed, as indicated by presence of unabsorbed water in the drum. Six test groups were prepared as described above. Each of the six test groups, and an uncoated control group, were evaluated by placing 1 kg of the test group (or control group) in a rotary drum while rotating, then adding increasing weight percentages of water and observing the behavior of the test group after each addition. Samples were withdrawn from the drum after each addition and placed into bottles for later evaluation. The results are shown in Table 2 below.

TABLE 2

| Test | |
|---|---|
| Group | Result |
| Control | Agglomeration into big granules at 4 wt. % water added |
| 1 | Agglomeration into big granules at 7 wt. % water added |
| 2 | Agglomeration into big granules at 6 wt. % water added |
| 3 | Some agglomeration, no flooding at 9 wt. % water added |
| 4 | No agglomeration, flooding observed at 3 wt. % water added |
| 5 | No agglomeration, flooding observed at 2 wt. % water added |
| 6 | No agglomeration, flooding observed at 2 wt. % water added |

As shown in Table 2, test groups 1 and 2 with about 0.5 wt. % coating tended to agglomerate into big granules indicative of caking at 6-7 wt. % water added. This is a significant improvement over the control group, which demonstrated agglomeration into big granules at 4 wt. % water added. Test groups 4-6 with greater than 1.5 wt. % coating did not show evidence of caking, but began flooding at 2-3 wt. % water added. Test group 3, with about a 1.1 wt. % coating showed resistance to caking and no evidence of flooding at least up to 9 wt. % water added. Thus, the test groups 1-5 with coating weight percentages ranging from 0.5 wt. % to 1.5 wt. % demonstrated improved moisture tolerance of 3 wt. % to 9 wt. % water added, compared to the test groups with greater that 2 wt. % coating weight percentages with a moisture tolerance of 2 wt. % water added. Surprisingly, test group 3 with a about 1.1 wt. % coating demonstrated a significantly higher moisture tolerance of 9 wt. % water added than even the 0.5 wt. % and 1.5 wt. % coatings.

### Caking Resistance and Caking Strength

The samples withdrawn from the drum and sealed into bottles after each water addition described above were evaluated to more accurately determine resistance to caking, as well as caking strength. While it is preferred that the granules do not cake, caking of granules with a low caking strength is permitted because the caked granules can easily be broken up into smaller granules suitable for use.

Caking resistance and caking strength were evaluated for each of the test groups and the control group by first turning the sealed bottle containing the sample upside down and observing if the granules are loose and fall to the bottom, indicating no caking, or if they remain at the top as caked granules. If caked granules were observed, then the capped bottle was then dropped a distance of 20 cm to a hard surface, and bottle again turned upside down to observe if the granules are loose and fall to the bottom, or if they remain at the top as caked granules. The absence of caked granules after the 20-cm drop indicates that the caking strength is low enough that the caked granules may be easily broken up into granular form for use. If caked granules were still observed, then the capped bottle was then dropped a distance of 40-cm to a hard surface, and bottle again turned upside down to observe if the granules are loose and fall to the bottom, or if they remain at the top as caked granules. The absence of caked granules after the 40-cm drop indicates that the caking strength is still low enough that the caked granules may be broken up into granular form for use without great difficulty. The results are show in Table 3 below. Table 3 shows the maximum amount of water added, as a weight percentage of sample, for which no caking is observed initially, after a 20 cm drop and after a 40-cm drop. Table 3 also includes the number of days the samples were sealed in the bottles before testing.

TABLE 3

| Test | No Caking | No Caking after | No Caking after | Days |
|---|---|---|---|---|
| Group | Initially | 20 cm Drop | 40 cm Drop | Sealed |
| Control | 0% | 0.5% | 1% | 2 |
| 1 | 0% | 2% | 3% | 13 |
| 2 | 0% | 1% | 2% | 13 |
| 3 | 0.5% | 5% | 7% | 2 |
| 4 | 3% | 5% | 11% | 7 |
| 5 | 3% | 10% | 10% | 7 |
| 6 | 5% | 10% | 10% | 7 |

As shown in Table 3, the test groups with 0.5 wt. % coating (groups 1 and 2) showed some improvement over the uncoated control group in the ease with which caked granules may be broken up, handling up to 3 wt. % water. The test groups with 2 wt. % and 3 wt. % coatings (groups 5 and 6), which displayed a controlled release profile, started flooding at around 4 wt. %, but were resistant to caking because the water could not penetrate the coating, dissolve some of the AMS, and recrystallize. Surprisingly, test groups with 1.1% and 1.52% coating (groups 3 and 4) demonstrated increasing caking resistance as well as a reduced caking strength, accommodating water additions up to 11 wt. %.

After the evaluation of the sealed bottles containing the test groups and the control group, the bottles were unsealed by removing their caps and permitted to air dry for 3 to 7 days in air with about 40% relative humidity to demonstrate any caking effect of recrystallization of dissolved ammonium sulfate. The test groups and control group were observed to be completely dry. Caking resistance and caking strength were re-evaluated for each of the test groups and the control group as described above. The results are shown in Table 4 below.

TABLE 4

| Test | No Caking | No Caking after | No Caking after |
|---|---|---|---|
| Group | Initially | 20 cm Drop | 40 cm Drop |
| Control | 0.5% | 1% | 1% |
| 1 | 1% | 3% | 3% |
| 2 | 2% | 2% | 2% |
| 3 | 3% | 4% | 7% |
| 4 | 11% | — | — |
| 5 | 3% | 10% | 10% |
| 6 | 5% | 10% | 10% |

As shown in Table 4, the results for the test groups with no coating (control group) or with 0.5 wt. % to 1.52 wt. % coating (test groups 1-4) demonstrate the evaporation of absorbed water from the incompletely coated or uncoated granules. The test groups with greater than 2 wt. % coating (test groups 5 and 6) showed little change. However, it is believed that if the test groups 5 and 6 were held in their flooded state for an extended period time simulating storage conditions (e.g. for 40 days), the dissolution of the AMS would result in caking and loss of product, while the test groups 1-4 would absorb and evaporate the moisture with little damage to the integrity of the fertilizer granules.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

We claim:

1. A moisture tolerant fertilizer granule comprising:
a core comprising a hygroscopic plant nutrient; and
a polyurethane polymer coating disposed on the core, wherein the polyurethane polymer coating is from 0.5 wt. % to 1.9 wt. % of the hygroscopic plant nutrient.

2. The moisture tolerant fertilizer granule of claim 1, wherein the polyurethane polymer coating is from 0.6 wt. % to 1.5 wt. % of the hygroscopic plant nutrient.

3. The moisture tolerant fertilizer granule of claim 1, wherein the polyurethane polymer coating is from 0.7 wt. % to 1.4 wt. % of the hygroscopic plant nutrient.

4. The moisture tolerant fertilizer granule of claim 1, wherein the polyurethane polymer coating is from 0.9 wt. % to 1.3 wt. % of the hygroscopic plant nutrient.

5. The moisture tolerant fertilizer granule of claim 1, wherein the hygroscopic plant nutrient includes an ammonium salt.

6. The moisture tolerant fertilizer granule of claim 1 wherein the hygroscopic plant nutrient includes ammonium sulfate.

7. The moisture tolerant fertilizer granule of claim 6, wherein the hygroscopic plant nutrient consists essentially of ammonium sulfate.

8. A fertilizer composition comprising:
a moisture tolerant fertilizer composition comprising:
moisture tolerant fertilizer granules, each of the moisture tolerant fertilizer granules comprising:
a core comprising a hygroscopic plant nutrient; and
a polyurethane polymer coating disposed on the core, wherein the polyurethane polymer coating is from 0.5 wt. % to 1.9 wt. % of the hygroscopic plant nutrient.

9. The fertilizer composition of claim 8, wherein the polyurethane polymer coating of the moisture tolerant fertilizer granules is from 0.7 wt. % to 1.4 wt. % of the hygroscopic plant nutrient.

10. The fertilizer composition of claim 8, wherein the polyurethane polymer coating of the moisture tolerant fertilizer granules is from 0.9 wt. % to 1.3 wt. % of the hygroscopic plant nutrient.

11. The fertilizer composition of claim 8, wherein the hygroscopic plant nutrient includes an ammonium salt.

12. The fertilizer composition of claim 8, wherein the hygroscopic plant nutrient includes ammonium sulfate.

13. The fertilizer composition of claim 8, further comprising a controlled release fertilizer composition.

14. The fertilizer composition of claim 13, wherein the controlled release fertilizer composition includes at least one compound selected from the group of urea, phosphorous pentoxide and potassium oxide.

15. A process for producing a moisture tolerant fertilizer composition, the process comprising:
contacting granules including a hygroscopic plant nutrient with a mixture comprising a polyol and an isocyanate; and
curing the mixture to form a polyurethane polymer coating on the granules including the hygroscopic plant nutrient, wherein the polyurethane polymer coating is from 0.5 wt. % to 1.9 wt. % of the hygroscopic plant nutrient.

16. The process of claim 15, wherein the polyurethane polymer coating is from 0.6 wt. % to 1.5 wt. % of the hygroscopic plant nutrient.

17. The process of claim 15, wherein the polyurethane polymer coating is from 0.7 wt. % to 1.4 wt. % of the hygroscopic plant nutrient.

18. The process of claim 15, wherein the polyurethane polymer coating is from 0.9 wt. % to 1.3 wt. % of the hygroscopic plant nutrient.

19. The process of claim 15, wherein the hygroscopic plant nutrient includes an ammonium salt.

20. The process of claim 15, wherein the hygroscopic plant nutrient includes ammonium sulfate.
